(19) United States
(12) Patent Application Publication
(10) Pub. No.: US 2006/0163118 A1
(43) Pub. Date: Jul. 27, 2006

(54) Particulate separation processes and apparatus

(75) Inventors: Jeffery P. Kelsey, Geneva, NY (US); Tomas G. McHugh, Webster, NY (US); Thomas M. Bragg, Auburn, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 11/043,529

(22) Filed: Jan. 26, 2005

(51) Int. Cl. B07B 9/00; B07B 13/16

(52) U.S. Cl. 209/21; 209/250

(57) ABSTRACT

The invention relates to processing particulates and apparatus therefor. More specifically, the invention is directed to processes and apparatus for separating particulates. According to various aspects of the invention, particulate separation processes and apparatus are provided comprising flowing a particulate over a foraminous wall and through a sieve.

### FIELD OF THE INVENTION

The invention relates to processing particulates and apparatus therefor. More specifically, the invention is directed to processes and apparatus for separating particulates.

### BACKGROUND OF THE INVENTION

Air-swept and vibratory sieves have been used to remove over-sized particulates and agglomerates from particulates. With combustible particulates, air-swept sieves require large explosion rated filter receivers to separate the material from the air stream, which are very high cost. Vibratory sieves tend to be noisy and high maintenance. Furthermore, air-swept sieves and vibratory sieves tend to be rather large. A compact sieving process and apparatus that provides particulate flows comparable to larger apparatus is desired.

### SUMMARY OF THE INVENTION

According to various aspects of the invention, particulate separation processes and apparatus are provided comprising flowing a particulate adjacent a foraminous wall and through a sieve.

### BRIEF DESCRIPTION OF THE DRAWINGS

FIG. 1 presents a schematic diagram of a process according to one aspect of the invention.

FIG. 2 presents a schematic cross sectional view of an apparatus according to one aspect of the invention.

FIG. 3 presents a schematic cross sectional view of an apparatus according to one aspect of the invention.

FIG. 4 presents a side view of an apparatus according to one aspect of the invention.

FIG. 5 presents a side cross-sectional view of the apparatus of FIG. 4.

FIG. 6 presents a representative graph of pressure versus time that may be applied to a pulse gas port, according to one aspect of the invention.

FIG. 7 presents a schematic cross sectional view of an apparatus according to one aspect of the invention.

FIG. 8 is a schematic representation of a grading system according to one aspect of the invention.

FIG. 9 is a schematic representation of a parallel flow system according to one aspect of the invention.

### DETAILED DESCRIPTION OF THE INVENTION

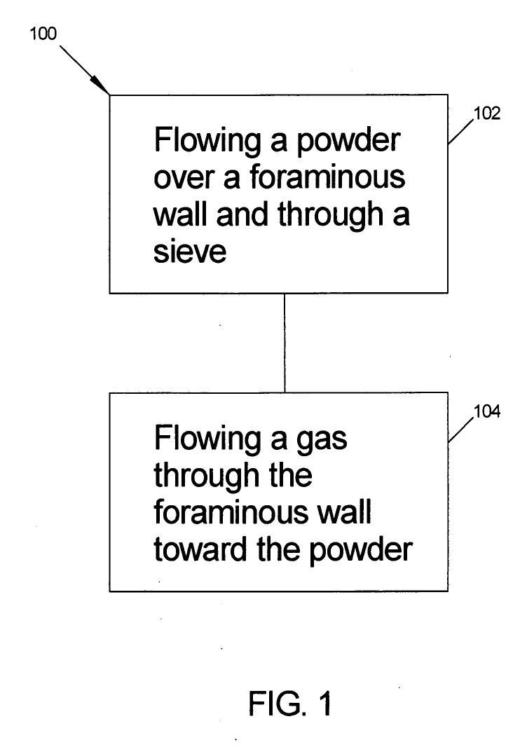

Various aspects of the invention are presented in FIGS. 1-9, which are not drawn to scale, and wherein like components are numbered alike. Referring now to FIG. 1, a particulate separation process 100, is presented comprising flowing a particulate over a foraminous wall and through a sieve, indicated by 102, and flowing a gas through the foraminous wall toward the particulate, indicated by 104. Flowing the particulate over the foraminous wall and through the sieve, and flowing the gas through the foraminous wall toward the particulate, may occur in any order, and may occur simultaneously in a continuous process. The particulate may be dry. The particulate may comprise granulated material, pellets, beads, powder, and such. According to a certain aspect of the invention, the particulate is a powder.

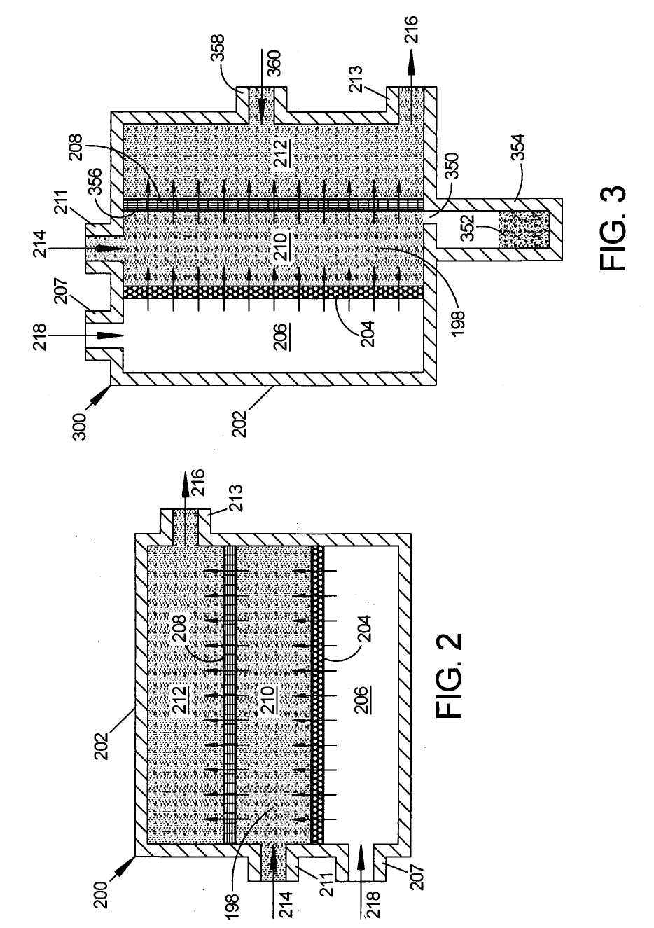

Referring now to FIG. 2, a particulate processing apparatus 200 is presented. The apparatus 200 comprises a hollow body 202. A foraminous wall 204 is disposed within the hollow body 202 and defines a supply gas input cavity 206 within the hollow body 202. A sieve 208 is disposed within the hollow body 202. The sieve 208 and the foraminous wall 204 define a particulate input cavity 210 within the hollow body 202. The sieve 208 defines a particulate output cavity 212 within the hollow body 202. The supply gas input cavity 206 has a supply gas inlet 207, the particulate input cavity 210 has a particulate inlet 211, and the particulate output cavity 212 has a particulate outlet 213.

Particulate 198 is introduced to the particulate input cavity 210 and flowed over the foraminous wall 204, as indicated by the arrow 214, between the foraminous wall 204 and the sieve 208. The particulate 198 is flowed through the sieve 208 into the particulate output cavity 212 and is extracted therefrom, as indicated by arrow 216. A gas, for example an inert gas such as nitrogen, is flowed into the supply gas input cavity 206 and through the foraminous wall 204 toward the particulate 198, as indicated by arrow 218. A non-inert gas may also be used, for example air, but an inert gas renders the device 200 explosion-proof for use with combustible particulates. Particles that do not pass through the sieve may be removed.

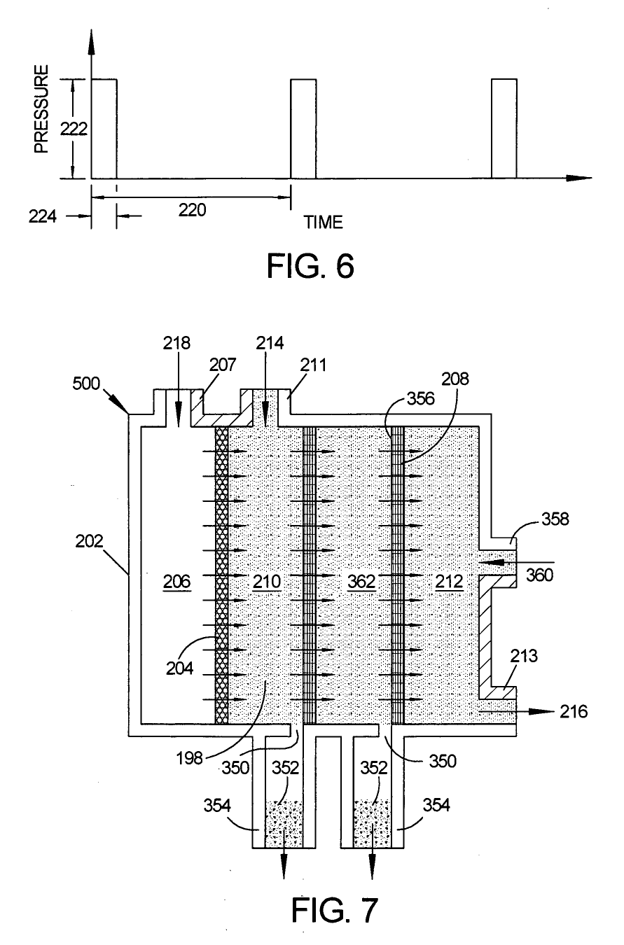

Referring now to FIG. 3, an apparatus 300 is presented wherein the particulate input cavity 210 has an overs outlet 350 for material 352 that does not pass through a sieve 208. “Overs” refers to particulates that do not pass through the sieve 208 (and may also be referred to as “oversize product”), and “unders” refers to particulates that do pass through the sieve 208 (and may be referred to as “undersized product”). In the example of FIG. 3, the sieve 208 has a vertical wall 356 and the particulate input cavity 210 has the overs outlet 350 disposed beneath the vertical wall 356 for material that does not pass through the sieve 208. The material simply drops through the overs outlet 350 by the force of gravity. An overs outlet conduit 354, which may include a trap, conduit, rotary valve, or other suitable structure, contains or transports the overs material 352 away from the apparatus 300. The particulate output cavity 212 may have a pulse gas port 358, and flow through the sieve 208 may be quickly and periodically reversed in order to dislodge material 352 that does not pass through the sieve 208 from the sieve 208 by applying periodic pressure pulses to the pulse gas port 358, as indicated by arrow 360. An example of a periodic pressure pulse is presented in FIG. 6, wherein the pulses have a period 220, a pulse amplitude 222, and a pulse duration 224. Examples for these values are presented on TABLE 1. The period (frequency) 220, pulse amplitude 222, and pulse duration 224 may be rendered adjustable by a controller.

TABLE 1

| | | |
|---|---|---|
| Period 220 | 1-60 | seconds |
| Pulse amplitude 222 | 5-50 | psi |
| Pulse duration 224 | 0.01-2 | seconds |

The pressure gradients within the apparatus 300 maintain flow of the particulate 198 through the apparatus 300, which prevents anything other than the overs material 352 from passing into the overs outlet 350. The overs material 352, or the unders material withdrawn from the particulate output cavity 212, or both, may be the desired product of the process and apparatus of the invention. Undesired material may be discarded or recycled.

According to one aspect of the invention, the foraminous wall 204 is impermeable to the particulate 198 to be processed. According to a further aspect of the invention the foraminous wall has a microporosity. An example of a suitable material is a Dynapore® sintered metal laminate, available from Martin Kurz & Company, Inc., Mineola, N.Y., U.S.A. According to Martin Kurz & Company product literature, Dynapore® porous metal laminates are constructed of one or more layers of stainless steel Wire mesh, laminated by precision sintering (diffusion bonding) and calendering. Sintering utilizes molecular diffusion to produce homogeneous metal bonds at each point of metal contact, including the wire crossover points within individual layers, as well as the contact points between each layer. The resultant monolithic structure is permanently bonded and has highly uniform porosity.

Although flowing gas through the foraminous wall may fluidize the particulate 198, the particulate 198 may be fluidized before flowing it over the foraminous wall 204. A fluidized particulate comprises particulate mixed with a gas (“gas fluidized”). According to one aspect of the invention, the resultant mixture flows like a fluid. Apparatus for fluidizing and moving particulate within conduits is disclosed in U.S. Pat. Nos. 6,609,871 and 6,682,290 both entitled “System for Handling Bulk Particulate Materials”, and U.S. Pat. Nos. 6,719,500 and 6,722,822 both entitled “System for Pneumatically Conveying Bulk Particulate Materials”, all naming John W. Pfeiffer and James E. Mothersbaugh as inventors, and all assigned to Young Industries, Inc., Muncy, Pa., U.S.A. Gas fluidized particulate from one or more of these devices may be fed to the apparatus according to the present invention, for example by connecting an output to the particulate inlet 211.

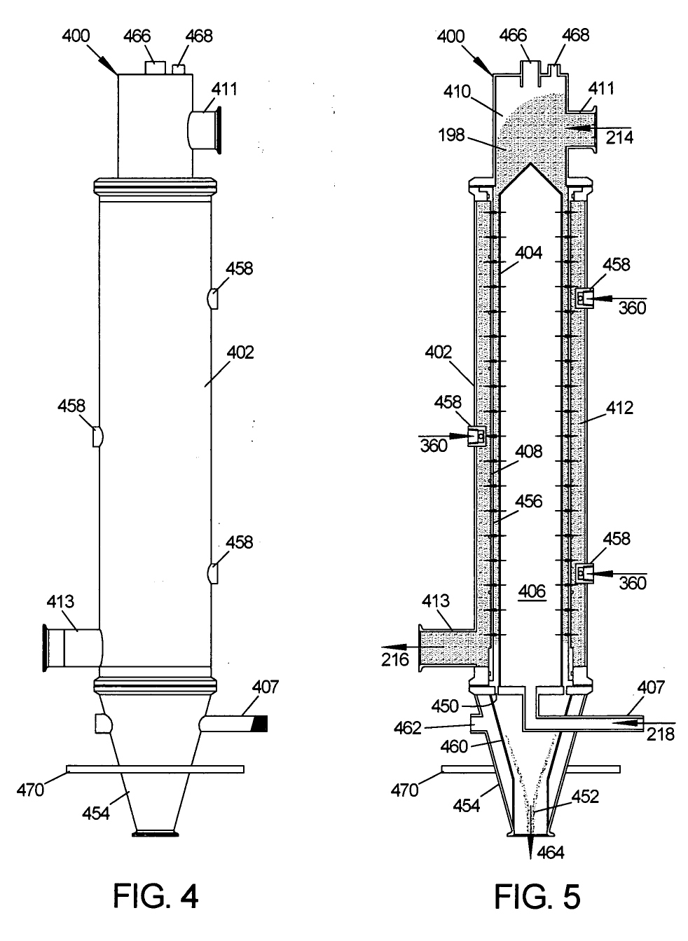

Referring now to FIGS. 4 and 5, an apparatus 400 is presented that is generally cylindrical. The apparatus 400 comprises a cylindrical hollow body 402. A cylindrical foraminous wall 404 is disposed within the hollow body 402 and defines a supply gas input cavity 406 within the hollow body 402. A cylindrical sieve 408 is disposed within the hollow body 402, the cylindrical sieve 408 and the cylindrical foraminous wall 404 defining a particulate input cavity 410 within the hollow body 402. The cylindrical sieve 408 defines a particulate output cavity 412 within the hollow body 402. The supply gas input cavity 406 has a supply gas inlet 407, the particulate input cavity 410 has a particulate inlet 411, and the particulate output cavity 412 has a particulate outlet 413. The cylindrical sieve 408 is nested outside the cylindrical foraminous wall 404.

The flows through the apparatus are as previously described in relation to apparatus 200 and 300. Furthermore, particles that do not pass through the sieve may be removed, as previously discussed in relation to FIG. 3. Still referring to FIGS. 4 and 5, the particulate input cavity 410 has an overs outlet 450 for material 452 that does not pass through the cylindrical sieve 408. In the example of Figures 4 and 5, the sieve 408 has a vertical wall 456 and the particulate input cavity 410 has the waste outlet 450 disposed beneath the vertical wall 456 for material that does not pass through the sieve 408. The material simply drops through the overs outlet 450 by the force of gravity. A conduit 454, trap, rotary valve, or other suitable structure may be provided to contain or transport the material 452 away from the apparatus 400. In the example presented the conduit 454 is conical, but it may be cylindrical or any other suitable shape, as may be desired. The particulate output cavity 412 may have one or more pulse gas ports 458, and flow through the sieve 408 may be quickly and periodically reversed in order to dislodge material 452 that does not pass through the sieve 408 from the sieve 408 by applying periodic pressure pulses of short duration to the pulse gas port 458, as indicated by arrow 360. The pressure gradients within the apparatus 400 maintain flow of the particulate 198 through the apparatus 400, which prevents anything other than material 452 from passing into the waste outlet 450.

The conduit 454 may comprise another foraminous wall 460 and another supply gas inlet 462. Flow of the supply gas through the foraminous wall 460 assists flow of the material 452 through the conduit 454 in direction of arrow 464, which may be in a gas fluidized state.

Further structure and/or ports may be added, as desired. For example, a cleaning medium port 466 may be provided for a cleaning medium, for example water and/or steam, and/or other cleaning medium as may be desired for a particular application. A gas may be used as a cleaning medium. The inside of the apparatus 400 may thus be cleaned, including the foraminous wall 404 and/or the sieve 408. Of course, this also applies to apparatus 200 and 300. Steam cleaning may be implemented for pharmaceutical applications or other applications wherein a sterile environment is desired. Another example of a port is a pressure measurement port 468. An example of structure that may be added is a support plate 470.

According to a certain embodiment for sieving electrographic toner for electrographic printing devices, the entire apparatus 400 is ASTM 304 or 316 stainless steel construction. The sieve 408 is a 40 micron profile wire screen assembly having a 4 inch inside diameter. The foraminous wall 404 is the previously described Dynapore® sintered metal laminate having a 3 and ⅜ inch outside diameter available as Trans-Flow permeable membrane from Young Industries, Inc., Muncy, Pa., U.S.A. The foraminous wall 404 and sieve 408 are generally coterminous in a longitudinal direction with a length on the order of 27 inches. Buna-N gaskets and heavy duty wing-nut tri-clamps hold the various components together. The supply gas inlet 407 is ½ inch standard pipe, the particulate inlet 411 is 2 inches in diameter, and the particulate outlet 413 is 2 inches in diameter. Flow rate of particulate 198 is 1000 pounds per hour with 10 SCFM (Standard Cubic Feet Per Minute) of nitrogen input to the supply gas inlet 407, and 2 SCFM of nitrogen input to the another supply gas inlet 462. With reference to FIG. 6, periodic pressure pulses are applied to the pulse gas ports 458 having a period 220 of 1 second, amplitude 222 of 10 psi, and pulse duration 224 of 25 milliseconds. Referring again to FIGS. 4 and 5, pressure greater than atmospheric pressure may be applied to the particulate inlet 411, and vacuum may be applied to the particulate outlet 413. Examples of powders that may be processed include electrographic toner, talc, pigments, carbon black, ceramic powders, and pharmaceutical compounds. These examples are not intended to be exhaustive.

Referring now to FIG. 7, a particulate processing cavity is presented comprising an intermediate cavity 362 and a plurality of sieves 208 and a plurality of overs outlets 354. The sieves 208 may comprise a progressively decreasing porosity. This causes finer material to be removed as the powder progresses from left to right through the apparatus 500. For example, starting from the left, the first overs outlet conduit 354 removes the coarsest particulate material, the second overs outlet conduit 354 removes a finer particulate material, and the finest particulate material is removed through the powder outlet 213. This process is sometimes referred to as “grading” or “taking cuts” (separating a particulate material into one or more ranges of sizes). Two or more intermediate cavities 362 and multiple overs outlets 354 and sieves 208 may be provided. The intermediate cavity/ies 362 may be provided with pulse gas ports 358 and thereby subjected to periodic gas pulses, as previously described with reference to FIG. 6.

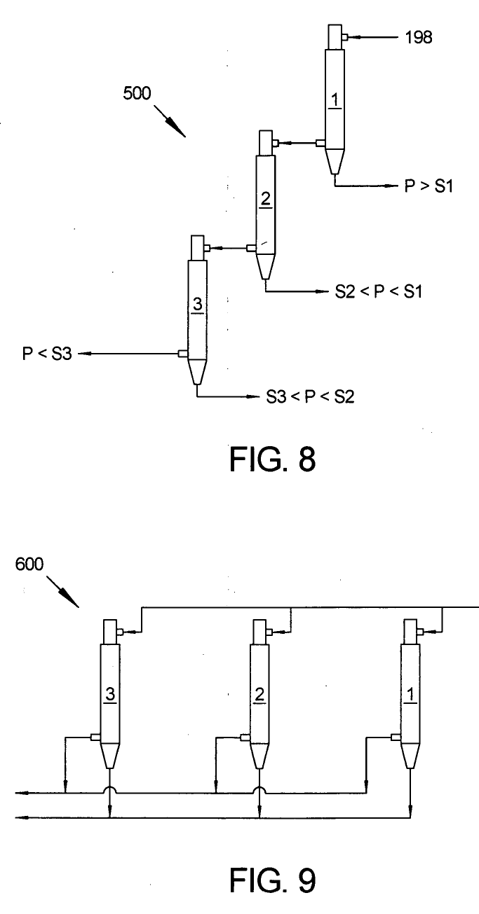

Referring now to FIG. 8 a schematic representation of a grading system 500 is presented that implements a first particulate separation apparatus 1, a second particulate separation apparatus 2, and a third particulate separation apparatus 3. Each of the apparatus 1, 2, and 3, may be configured as apparatus 400 of FIGS. 4 and 5, with sieves 408 having a decreasing porosity from apparatus 1 to apparatus 3 (1>2>3). Still referring to FIG. 8, particulate 198 enters the top of apparatus 1. Particles P greater than size S1, exit the bottom of apparatus 1. The effluent from the left of apparatus 1 is fed to the top of apparatus 2. Particles P less than size S1 and greater than size S2 exit the bottom of apparatus 2. The effluent from the left of apparatus 2 is fed to the top of apparatus 3. Particles P less than size S2 and greater than size S3 exit the bottom of apparatus 3. Particles less than size S3 exit the left of apparatus 3. The grading system 500 may have two or more separation apparatus to provide graded output, as may be desired.

Referring now to FIG. 9 a schematic representation of a parallel flow system 600 is presented that implements a first particulate separation apparatus 1, a second particulate separation apparatus 2, and a third particulate separation apparatus 3. Each of the apparatus 1, 2, and 3, may be configured as apparatus 400 of FIGS. 4 and 5, with sieves 408 having the same porosity from apparatus 1 to apparatus 3 (1=2=3). The system 600 is capable of handling 3 times the flow that a single apparatus could handle. The parallel flow system 500 may have two or more separation apparatus to provide a quantity of particulate throughput, as may be desired.

The claims should not be read as limited to the described order or elements unless stated to that effect. As used herein, “first”, “second”, and “third” are used for reference only, do not indicate any particular order, and are not intended to limit the invention. In addition, use of the term “means” in any claim is intended to invoke 35 U.S.C. §112, paragraph 6, and any claim without the word “means” is not so intended.

Although the invention has been described and illustrated with reference to specific illustrative embodiments thereof, it is not intended that the invention be limited to those illustrative embodiments. Those skilled in the art will recognize that variations and modifications can be made without departing from the true scope and spirit of the invention as defined by the claims that follow. It is therefore intended to include within the invention all such variations and modifications as fall within the scope of the appended claims and equivalents thereof.

### PARTS LIST

100 dry particulate process
102 flowing a particulate over a foraminous wall and through a sieve
104 forcing a gas through the foraminous wall toward the particulate
198 particulate
200 apparatus
202 hollow body
204 foraminous wall
206 supply gas input cavity
207 supply gas inlet
208 sieve
210 particulate input cavity
211 particulate inlet
212 particulate output cavity
213 particulate outlet
214 arrow
216 arrow
218 arrow
220 period
222 pulse amplitude
224 pulse duration
300 apparatus
350 overs outlet
352 material
354 trap
356 vertical wall
358 pulse gas port
360 arrow
362 intermediate cavity
400 apparatus
402 cylindrical hollow body
404 cylindrical foraminous wall
406 supply gas input cavity
407 supply gas inlet
408 cylindrical sieve
410 particulate input cavity
411 particulate inlet
412 particulate output cavity
413 particulate outlet
450 waste outlet
452 material
454 conduit
456 vertical wall
458 pulse gas port
460 another foraminous wall
462 another supply gas inlet
464 arrow
466 cleaning port
468 pressure measurement port
470 support plate
500 apparatus
600 apparatus

1. A particulate separation process, comprising:
flowing a particulate adjacent a foraminous wall and through a sieve; and flowing a gas through the foraminous wall toward the particulate.

2. The process of claim 1, comprising gas fluidizing the particulate before flowing the particulate over the foraminous wall.

3. The process of claim 1, comprising water or steam cleaning the sieve.

4. The process of claim 1, comprising gas cleaning the sieve.

5. The process of claim 1, comprising flowing the particulate between the foraminous wall and the sieve.

6. The process of claim 1, the foraminous wall and the sieve being disposed within a hollow body.

7. The process of claim 1, the foraminous wall and the sieve being disposed within a hollow body;
(a) the foraminous wall and the hollow body defining a supply gas input cavity within the hollow body, and comprising supplying gas to the supply gas input cavity;
(b) the sieve and the foraminous wall defining a particulate input cavity within the hollow body, and comprising supplying particulate to the particulate input cavity;
(c) the sieve defining a particulate output cavity within the hollow body, and comprising extracting sieved particulate from the particulate output cavity.

8. The process of claim 1, comprising removing particles that do not pass through the sieve.

9. The process of claim 1, the foraminous wall being impermeable to a particulate to be processed.

10. The process of claim 1, the foraminous wall comprising microporosity.

11. A particulate processing apparatus, comprising:
(a) a hollow body;
(b) a foraminous wall disposed within the hollow body and defining a supply gas input cavity within the hollow body;
(c) a sieve disposed within the hollow body, the sieve and the foraminous wall defining a particulate input cavity within the hollow body; and
(d) the sieve defining a particulate output cavity within the hollow body.

12. The apparatus of claim 11, the particulate output cavity comprising a pulse gas port.

13. The apparatus of claim 11, the particulate input cavity comprising an overs outlet for material that does not pass through the sieve.

14. The apparatus of claim 1, the sieve comprising a vertical wall and the particulate input cavity comprising an overs outlet disposed beneath the vertical wall for material that does not pass through the sieve.

15. The apparatus of claim 11, the foraminous wall being cylindrical and the sieve being cylindrical.

16. The apparatus of claim 11, the foraminous wall being cylindrical and the sieve being cylindrical and nested outside the foraminous wall.

17. The apparatus of claim 11, the foraminous wall being impermeable to a particulate to be processed.

18. The apparatus of claim 11, the foraminous wall comprising microporosity.

19. The apparatus of claim 11, the hollow body comprising a cleaning medium port.

20. A particulate processing apparatus, comprising:
(a) a hollow body;
(b) a foraminous wall disposed within the hollow body and defining a supply gas input cavity within the hollow body, the foraminous wall being impermeable to a particulate to be processed;
(c) a sieve disposed within the hollow body, the sieve and the foraminous wall defining a particulate input cavity within the hollow body;
(d) the sieve defining a particulate output cavity within the hollow body;
(e) the particulate output cavity comprising a pulse gas port.
